(19) United States
(12) Patent Application Publication
(10) Pub. No.: US 2004/0179553 A1
(43) Pub. Date: Sep. 16, 2004

(54) Method and apparatus for localizing data

(76) Inventor: Marcus Wiklund, Helsinki (FI)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/474,209

(22) PCT Filed: Apr. 22, 2002
(86) PCT No.: PCT/FI02/00331

(30) Foreign Application Priority Data
Apr. 20, 2001 (FI) 20010822

(51) Int. Cl. H04J 1/00

(52) U.S. Cl. 370/486; 370/438

(57) ABSTRACT

The present invention relates to a method and a digital transmission system for localizing data in a digital network environment. The digital transmission system comprises a data transmitting means and a data localization means. The data transmitting means further comprise a transmit unit and means for providing a digital data stream and triggering data coupled to command information to a data localization means. The data localization means comprise receiving means for receiving the digital data stream and triggering data coupled to command information, means for detecting triggering data, triggering means, information transmission means, command processing means, operational processing means, and means for altering the received digital data stream in accordance with command(s).

### TECHNICAL FIELD OF THE INVENTION

The present invention relates to a method, a digital transmission system, a data transmitting means, a data localizing means and a use of a system for localizing data in a digital network environment.

### BACKGROUND OF THE INVENTION

The digital broadcasting has developed rapidly in the past few years. The digital broadcasting provides numerous benefits compared to the analogue broadcasting, e.g., improved operational flexibility, possibility for new services that go beyond the scope of the conventional television programs for the broadcaster, and improved video and audio quality, improved program and service choices and possibility for interactivity with the service provider for the user. In this context the term ‘program’ refers to a collection of elementary data streams that are logically related and belong together as defined in the MPEG (Moving Pictures Experts Group) terminology. With the term ‘event’ the MPEG terminology covers ‘a time limited transmission’ and with the term ‘service’ the MPEG terminology covers ‘a sequence of the time limited transmissions’.

Since the main consideration of the present invention is Digital Video Broadcasting (DVB), the specification generally considers the techniques of the DVB. Even though the specification considers mainly DVB, the invention is applicable also to the Digital Audio Broadcasting (DAB) as specified by the various standardization organizations in their technical specifications. Various organizations, such as ETSI (European Telecommunications Standards Institute), ISO (International Organization for Standardization), ITU (International Telecommunications Union), have provided technical specifications and standards for the various features of the DVB and their implementations to the broadcasting systems. Furthermore, the present invention is applicable also to offer multicast systems, which may be in the Internet type environments.

DVB is not restricted to cover only the transmission of the video content, but it also covers data broadcasting services that comply with the DVB standard. DAB differs from the DVB mainly by the encoding and decoding features. While the DAB implements MPEG-1 or MPEG-2 standards, defined by for example ETSI, the DVB implements MPEG-2 standards for the data compression. Therefore, the DAB implements the same basic features for data broadcasting as the DVB data broadcasting. In multicast systems, the video content implements MPEG-2 standards for the data compression, and the audio content implements MPEG-1 or MPEG-2 standards for the data compression, also other kind of compression may be used for the data compression. The data compression in the Internet environment is defined by IETF (Internet Engineering Task Force), or the compression standards that are ‘de facto’ standards.

The digital broadcasting in general consists of the following actions. Video, audio and data are encoded, in their respective encoders, into Packetized Elementary Streams (PES). The PES streams are provided to a multiplexer together with timing data and control/other data.

The control/other data may contain, e.g., Service Information (SI) or Program Specific Information (PSI), possible conditional access (CA) and possible private data. The multiplexer multiplexes the PES streams and control/other data into a transport stream (TS), which is transmitted, e.g., via satellite, to a receiving local system. The transport stream is then demultiplexed and decoded into single program streams that can be transmitted, after processing locally into a transport stream, forward from the local system to the users of the service (alternatively the transport stream can be transmitted to the satellite dish of the user).

Even though the digital broadcasting has been widely standardized by the various organizations, the standards rely on the fact that the data is transmitted to the local service providers in the form that they will be broadcasted to the users. The standards and modern day solutions for localizing data streams are rather complex or require manpower to handle the localization of the data streams.

For example, in Sweden, some of the local service providers broadcast program streams that are transmitted from England. In Sweden, the legislation prohibits showing commercials in the middle of a program in a terrestrial network. Therefore, when the satellite transmission (e.g., from England) is received in a local service provider for further broadcasting to the viewers, the commercials in between the program streams must be covered. This has been implemented by some of the service providers by a manual change from a commercial to a picture that informs the viewers that there are commercials broadcasted in other countries at the moment. Usually, there are 10 frames or a 400 ms delay between the program and the start of the commercial, which is demanding for an operator when the change between program stream and a still picture (or alike) is implemented manually. Quite often the viewers have been able to see the beginning of the commercial. There have also been situations, when the operator has not noticed quickly enough that the commercials end and the program continues. In this case the viewers have been unable to see the beginning of the program after the commercials. The disadvantages of the manual change are that the service provider needs manpower to handle the change between the program and commercials all the time and the reliability of the functions implemented by the manpower. Especially if the program stream is transmitted from e.g., England around the day, the operator costs will be quite noticeable in a year.

Another solution for changing between a commercial and a still picture has been implemented by some other service providers. In this method, the service provider utilizes the feature that is made possible by the analogue teletext. In this method, the first pulse in a teletext (indicating a start of a commercial) starts a video server to replace the commercials with a still picture, and the next pulse in a teletext turns off the video server that replaces the program stream with a still picture. The disadvantages of the method is that the method is capable of only controlling one function of a program stream and if one pulse is deleted in a program stream, the video server most likely replaces the program stream (i.e., a movie or a series) and broadcasts the commercials to the viewers instead. The pulse of the teletext is capable only to be used for starting the next file or block in a command sequence of the video server.

In some Islamic countries, it is prohibited to broadcast e.g., alcohol commercials to the viewers. In these countries the foreign programs are delayed for the censoring. A large number of censors delete alcohol commercials, etc. from the program stream. The method for deleting some parts of the program stream is complex since there is a need for many censors, and the program stream must be delayed for censoring purposes.

### SUMMARY OF THE PRESENT INVENTION

It is an object of the present invention to overcome or at least mitigate the disadvantages of the prior art. The present invention provides a method, a digital transmitting system, a data transmitting means, a data localization means and a use of a system for localizing data in a digital network environment.

It is an object of the present invention to provide an automated detection of triggering information and the localization of the digital data.

According to a first aspect of the present invention there is provided a method for localizing data in a digital network environment, said method comprising the steps of:

providing a digital data stream at a remote transmitting means,

providing triggering data coupled to command information capable of altering said digital data stream,

receiving said digital data stream and said triggering means coupled to said command information at a local receiving means,

in said local receiving means, detecting said triggering data in a detecting means,

in response to any detected triggering data, sending said command information to command processing means,

sending information from said command processing means to one or more operational processing means for execution of command(s) in accordance with said command information,

altering said received digital data stream in accordance with said command(s).

Preferably, said triggering data coupled to said command information and said digital data stream are transmitted together from said remote transmitting means. Alternatively, said triggering data coupled to said command information is transmitted from a separate transmitting means.

Preferably, said digital data stream which is to be localized comprises broadcasting data such as a service stream in a Digital Video Broadcasting (DVB) or a Digital Audio Broadcasting (DAB) network or multicasting data such as a service stream in a communications network. Alternatively, said digital data stream which is to be localized comprises information retrievable from an information network such as the Internet.

Preferably, said triggering data coupled to said command information is introduced into a private table which is combined with said digital data stream. More preferably, said triggering data coupled to said command information is introduced into said table by an automation means. Alternatively, said triggering data coupled to said command information comprises auxiliary data which is combined with or introduced into said digital data stream.

Preferably, said digital data stream comprises a stream for a single service or part thereof in a multiple service stream composed of several independent services in a DVB or DAB network said multiple service stream being transmitted by a remote transmit unit. Alternatively, said digital data stream comprises a single service or communication data stream among multiple data in a multicast or communications network.

More preferably, said multiple service or data stream comprises encoded data which is combined in a multiplexer means with said triggering data coupled to said command information. The encoded and multiplexed service or data stream is transmitted as a transport stream from a remote transmitting means through a network to said local receiving means where it is demultiplexed to provide several independent service or data streams. At least said single service or data stream is decoded after demultiplexing.

Preferably, said triggering data comprises a triggering label comprising a set of characters recognizable by a triggering device as a command for initiating an operation defined by said command information.

Preferably, said command information is capable of causing modification of said digital data stream and includes one or more commands to be executed for causing such modification. Said commands are selected from direct commands and composite commands, wherein said direct command includes digital information such as operational processor identification, operation identification, operation parameters, delay time, and/or the like parameters and said composite command includes digital information such as operational processor identification, operation identification, operation parameters, delay time and/or the like parameters.

Preferably, said triggering data is included in a private table in a multiplexed data stream and reading of said triggering data causes command(s) included in said command information to be sent to said command processing means for execution. More preferably, said command processing means send direct and/or composite command(s) to one or more operational processing means identified in said command information. Said operational processing means comprise a demultiplexing device, a decoding device, an encoding device, a remultiplexing device, a server device, a mixer device, a text generator device, a data carousel, or the like service influencing device. Said single service stream comprises a program stream in a DVB or DAB network and said single stream is routed through a first port in a video or audio stream mixing device and, in response to a command received from said command processing means, said first port is closed and a second port is opened allowing another video or audio program stream to modify and/or replace said single service stream. A command is simultaneously received in a video or audio server device to send a selected video or audio program stream to said second port for replacing said single service stream.

Preferably, said first port in said mixing device is reopened and said second port closed after a delay time determined by said command information to allow said single service stream to be reassumed. More preferably, said service stream is routed after said mixing device to encoding and remultiplexing for further transmission to local users.

Alternatively, said single service stream comprises an application or data stream in a network and said single stream is deleted in a remultiplexing device totally or for a delay time in response to a command received from said command processing means. A command is simultaneously received in a data carousel to send a selected data stream or package to said remultiplexing device for replacing said single service stream.

Alternatively, said single service stream comprises a service or a data stream in a network and wherein said single stream is modified by the combining of an additional data stream with said single stream in a remultiplexing device in response to a command received from said command processing means. Alternatively, said single stream comprises a service or communication data stream in a communications network and, in response to a command received from said command processing means, said single stream is modified by a selected data stream introduced from a server device.

Preferably, said selected stream comprises a local stream such as a local advertisement, local news, local dubbing, local subtitling, local text content, local censoring replacement, local identification, or local application.

According to a second aspect of the present invention there is provided a digital transmission system for localizing data in a digital network environment, said digital transmission system comprising:

remote transmitting means for transmitting digital data streams,

means for providing triggering data coupled to command information,

local receiving means for receiving the digital data stream and triggering data coupled to command information,

means at said local receiving means for detecting said triggering data,

triggering means arranged, in response to any detected triggering data, to send said command information to command processing means,

information transmitting means for sending information from said command processing means to one or more operational processing means for execution of command(s) in accordance with said command information,

means for altering said received digital data stream in accordance with said command(s).

Preferably, said means for providing triggering data coupled to command information is said remote transmitting means. Alternatively, said means for providing triggering data coupled to command information is a separate transmitting means.

Preferably, said network comprises a Digital Video Broadcasting (DVB), a Digital Audio Broadcasting (DAB) network, a multicasting network or a communications network.

Preferably, the digital transmission system further comprises means for adding said triggering data coupled to said command information into or into combination with said digital data stream.

The digital transmission system preferably, further comprises automation means for introducing said triggering data coupled to said command information data into a private table of a digital broadcasting or multicasting signal.

Preferably, said remote transmitting means includes encoding means to encode digital data streams and multiplexing means for multiplexing digital data streams with one or more other data streams to be transmitted.

Preferably, the digital transmission system further comprises means for demultiplexing and decoding data streams received in said receiving means.

Preferably, said operational processing means comprise a demultiplexing device, a decoding device, a remultiplexing device, an encoding device, a mixer device, a server device, a text generator, a data carousel, or the like processing device.

According to a third aspect of the present invention there is provided a data transmitting means for localizing data in a digital network, said data transmitting means comprising:

a transmit unit for transmitting digital data streams,

means for combining a digital data stream to be transmitted with triggering data coupled to command information, said command information being capable of causing a modification of said digital data stream at local receiving means.

Preferably, said network comprises a broadcasting network such as a Digital Video Broadcasting (DVB) or a Digital Audio Broadcasting (DAB) network, a multicasting network or a communication network such as the Internet.

Preferably, the data transmitting means further comprises means for adding said triggering data coupled to said command information into or into combination with said digital data stream.

Preferably, the data transmitting means further comprises automation means for introducing said triggering data coupled to said command information data into a private table of a digital broadcasting or multicasting signal.

Preferably, said transmit unit includes encoding means for encoding said digital data stream and multiplexing means for multiplexing said digital data stream with one or more other data streams to be transmitted and with said triggering means coupled to said command information.

According to a fourth aspect of the present invention there is provided a data localizing means for localizing data in a digital network environment comprising:

local receiving means for receiving a digital data stream and triggering data coupled to command information from remote transmitting means,

means at said local receiving means for detecting said triggering data,

triggering means arranged, in response to any detected triggering data, to send said command information to command processing means,

information transmission means for sending information from said command processing means to one or more operational processing means for execution of command(s) in accordance with said command information,

means for altering the received digital data stream in accordance with said command(s).

Preferably, the data localizing means comprises separate local receiving means and/or separate remote transmitting means for said digital data stream and said triggering data, respectively.

Preferably, the data localizing means further comprises means for demultiplexing and/or decoding received encoded data streams.

Preferably, said operational processing means comprise a demultiplexing device, a decoding device, an encoding device, a remultiplexing device, a mixer device, a server device, a text generator, a data carousel, or the like. Preferably, said mixer device is a video or audio stream mixer and comprises a first and a second port, which ports can be opened and closed to allow a video or audio program stream to modify and/or replace another program stream. Alternatively, said remultiplexing device comprises a remultiplexer for deleting said digital data stream, modifying said digital data stream and/or adding data into or into combination with said digital data stream.

According to a fifth aspect of the present invention there is provided use of a system for localizing data in a digital network environment, said use comprising:

controlling local data in a remotely transmitted digital data stream in a data localization means based on triggering data coupled to command information provided from a transmitting means, said command information being capable of causing modification of said digital data stream at local receiving means.

Preferably, said digital data stream which is to be localized comprises multicasting data or broadcasting data such as a program stream in a Digital Video Broadcasting (DVB) or a Digital Audio Broadcasting (DAB) network, or information retrievable from an information network such as the Internet.

Preferably, said local data comprises insert or replacement data introduced into the digital data stream in response to commands included in said command information. More preferably, said local data comprises local advertisement(s), local news, local dubbing, local subtitling, local text content, local censoring replacement, local identification, or local applications.

Preferably, the use of the system comprises providing local news and/or local inserts in an international DVB or DAB transmission. Alternatively, the use of the system comprises providing local news and/or local inserts in an international news service on the Internet.

Preferably, the use of the system comprises causing selected interrupting local information to be introduced into broadcasting and/or communications networks.

Alternatively, the use of the system prevents selected services from being transmitted to local receivers in a broadcasting and/or communications network.

The present invention provides a simple manner for localizing data in a digital network environment. The invention further automates detecting the triggering data and performing the data localization in data localization means according to the present invention. This feature of the invention helps the service providers to lower the costs for localizing the data and to eliminate the mistakes made compared to the manpowered data localization. The present invention further provides that the replaced data stream format may differ from the original data stream format.

### BRIEF DESCRIPTION OF THE DRAWINGS

For a better understanding of the present invention and in order to show how the same may be carried into effect reference will now be made to the accompanying drawings, in which:

FIG. 1 shows schematically the preferred embodiment of the present invention.

FIG. 2 shows an alternative embodiment of the present invention.

FIG. 3 shows schematically an alternative embodiment of the present invention.

FIG. 4 shows schematically an alternative embodiment of the present invention.

FIG. 5 shows an alternative embodiment of the present invention.

FIG. 6 is a flowchart illustrating the method of the preferred embodiment of the present invention.

### DETAILED DESCRIPTION OF CERTAIN EMBODIMENTS

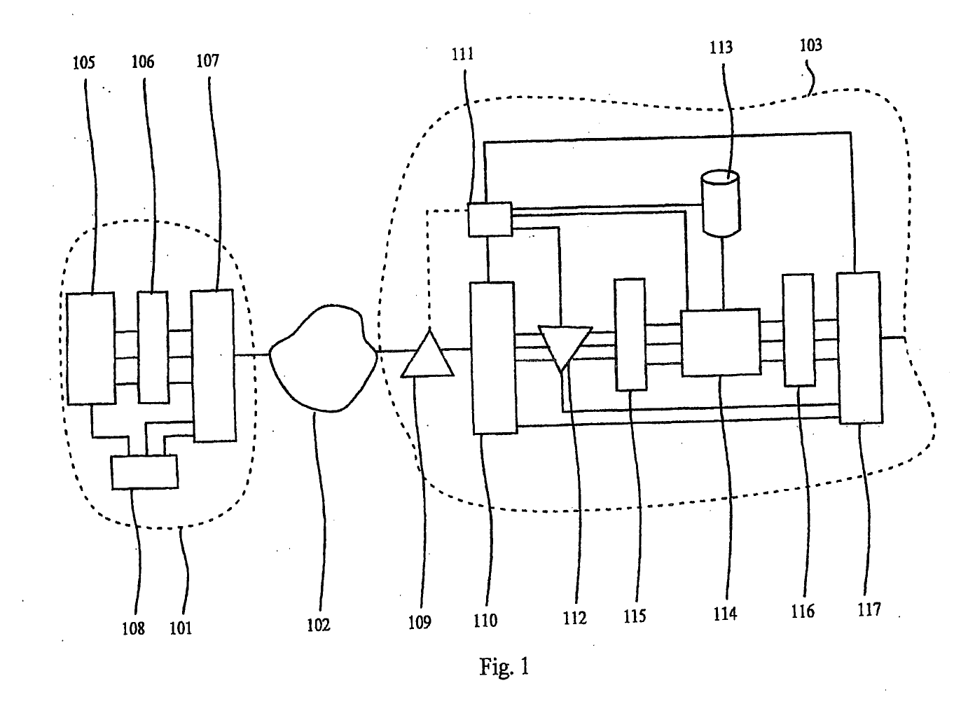

FIG. 1 shows schematically the preferred embodiment of the present invention. FIG. 1 shows an inventive concept of the present invention, i.e., the system for controlling automatic equipment locally through the commands received in a transmission signal. Even though the figure illustrates the present invention in terms of the Digital Video Broadcasting (DVB), the equipment utilized for the DVB transmission may also be utilized e.g., for Digital Audio Broadcasting (DAB).

FIG. 1 shows remote transmitting means 101, a transportation network 102, and data localization means 103. Inventive concept of the present invention provides a method, an arrangement and apparatus for providing data stream(s) from remote transmitting means 101 through a transportation network 102 to data localization means 103 for localizing data, which is further transmitted to the users (not shown in FIG. 1) of the data service.

In an embodiment of the present invention, a transmit unit 105 provides multiple digital data streams, in this presentation the data also covers programs, for an encoder 106. The digital data stream comprises stream for a single service or part thereof in a multiple service stream composed of several independent services in a DVB or DAB or multicast or communications network. The encoder 106 encodes the different forms of data with their respective encoders, i.e., video data is encoded according to MPEG-2 standards (or according to corresponsive standards such as MPEG-4 or MPEG-7 standards) as defined by various standardization organizations, audio is encoded according to MPEG-1 or MPEG-2 standards (or according to corresponsive standards such as MPEG-4 or MPEG-7 standards). There after, the encoder 106 provides the encoded digital data streams to a multiplexer 107, which combines the digital data streams with additional information to form a single transport stream. The additional information includes e.g., timing information of various data streams, Service Information (SI) or Program Specific Information (PSI), Conditional Access (CA) information and private data information. The additional information is mainly specified by the standards of the digital broadcasting, but the standardization committees have left some of the elements of the additional information to be defined by the user. The encoding and multiplexing of the transport stream is disclosed e.g., in the ISO/IEC 13818-1 standard, which is enclosed in the present invention, and therefore, it is not disclosed in details herein.

The digital data stream, which is to be localized, comprises broadcasting data such as a service stream in a Digital Video Broadcasting (DVB) or a Digital Audio Broadcasting (DAB) network or multicasting data such as a service stream in communications network. Alternatively, the digital data stream comprises information retrievable from an information network such as the Internet.

According to the present invention, an automation system 108 provides triggering information coupled to respective command information into the Private Data Tables (PDT) and provides the PDTs to the multiplexer 107 that multiplexes the digital data streams with the additional information. Private Data Tables are also referred as private tables in the art. Triggering information, according to the present invention, comprises a triggering label (comprising a set of characters recognizable by a triggering device as a command for initiating an operation defined by said command information), which informs the local receiving means that a data stream should be modified locally. The triggering information may alternatively be an auxiliary data, which is combined with or introduced into said digital data stream. Command information is capable of causing modification of said digital data stream and includes one or more commands to be executed for causing such modification. The command can be direct commands or composite commands. The direct commands includes digital information such as: operational processor identification, operation identification, parameters, delay time and/or the like parameters. The operational processor identification identifies the operational processor (i.e., a device) that should utilize the command. The operation identification identifies the operation that is needed to be executed. The parameters define what should be done and how. The composite commands includes digital information such as: operational processor identification, operation identification, operation parameters, delay time and/or the like parameters. The automation system 108 further controls the transmit unit 105 by providing e.g., playlist that informs the transmit unit 105 of timing, etc.

After multiplexing the digital data streams and the additional information into a transport stream, the multiplexer 107 transmits the transport stream through a transportation network 102 to the local receiver 109 of the data localization means 103. The transportation network 102 can be for example a satellite or a cable network.

After receiving the transport stream in the local receiver 109, the transport stream is provided for a demultiplexer 110. The demultiplexer 110 detects (i.e., scans) the triggering information (i.e., the triggering labels, which are included in the PDT, coupled to said command information) from the received transport stream. Even though in this presentation the local receiver 109 and the demultiplexer 110 are physically separated, it is done only to illustrate the inventive concept more closely. The local receiver 109 and the demultiplexer 110 can be a single device (i.e., local receiving means) that is capable of receiving the digital data stream, detecting any triggering information coupled to said command information, providing the triggering information coupled to said command information to a command processor (or a like) and demultiplexing the digital data stream.

In case the triggering information is found in a transport stream, the demultiplexer 110 transmits the triggering information coupled to said command information to a command processor 111. Otherwise, the demultiplexer 110 transmits the transport stream to the remultiplexer 117. The command processor 111 receives the information included in one or several commands and sends the information to the device(s) identified in the command to execute an operation that has been defined and identified in the command. The information is usually sent from said command processor 111 to one or more operational processing means for execution of command(s) in accordance with said command information. The operational processing means can be e.g., a demultiplexing device 110, a decoding device 115, an encoding device 116, a remultiplexing device 117, a server device 113, a mixer device 114, a text generator device, a data carousel, or the like service influencing device. The command processor 111 can control any system if the system can be located by unique address. The address may be e.g., Internet Protocol (IP) address. Essentially at the same time the demultiplexer 110 demultiplexes the transport stream into several data streams in a demultiplexer 110, which it provides to a controller 112.

In case the data stream consisting a television program and the command is to change a commercial with an application (e.g., a live video feed), the command processor 111 informs a video server 113 to start providing e.g., the live video feed data stream to a mixer 114. One of the advantages of the present invention is that the form of the replaced data stream may differ from the data stream received from the remote transmitting unit 101. For example, the video feed transmitted from the remote transmitting means 101 can be replaced with a live transmission. At the same time the command processor 111 sends a command to the controller 112 to block the data stream(s) (containing at least a part of the television program) and to the mixer 114 to retransmit the live video feed data stream (or a named video stream file) received from the video server 113 for a certain time. When the controller 112 receives a command to block the data stream(s), the controller blocks the data stream(s), which is otherwise routed through a first port of a mixer 114. The blocking of the data stream(s) may also be done by closing the first port of the mixer 114. At the same time a second port of the mixer 114 opens allowing another file (e.g., a video or an audio file) to replace the data stream(s) provided by the controller 112.

When the certain time is passed the controller 112 continues to provide the data stream(s), the mixer 114 reopens the first port and closes the second port of the mixer 114, received from the demultiplexer 110 to the mixer 114, which retransmits the data stream and blocks the information that is still possibly transmitted from the video server 113. The data stream provided from the controller 112 to the mixer 114 is decoded there between in a decoder 115, which decodes the data streams. There may be a different decoder for each type of the data streams, i.e., a video decoder for a video stream or an audio decoder for an audio stream.

Even though the server 113 has been identified as a video server, it can also be e.g., a text generator device, a logo generator device, etc.

The mixer 114 retransmits the localized data stream (whether the data stream received from the decoder 115 and/or from the video server) to an encoder 116, which encodes the localized data stream and provides the encoded localized data streams to a remultiplexer 117 for multiplexing the data streams into a transport stream for further transmission.

Alternatively in case the data stream (e.g., a television program) is modified with an additional information, e.g., changing a logo of a television station into another, the process follows the steps of transmitting the data from the remote transmitting means 101 to the local receiver 109, detecting the triggering information (coupled to said command information) and demultiplexing the transport stream in a demultiplexer 110, transmitting the triggering information coupled to said command information to the command processor 111, and providing the data streams to the controller 112. The processes differ from each other in the way the data stream, which will be provided to the user, is controlled. The command processor 111 informs a server (e.g., a logo generator server) 113 to start providing a data stream, comprising a television station logo (or a like) to a mixer 114. At the same time the command processor 111 sends a command to the controller 112 to transmit the data stream(s) (containing at least a part of the television program) to the mixer 114. Further, at the same time the command processor 111 sends a command to the mixer 114 to retransmit the data stream received from the controller 112 combined with a data stream (e.g., an image file) received from the server 113. The data stream provided from the controller 112 to the mixer 114 is decoded there between in a decoder 115, which decodes the data streams. There may be a different decoder for each type of the data streams, i.e., a video decoder for a video stream or an audio decoder for an audio stream.

Further alternative embodiment to the preferred embodiment of the present invention described is shown by a dashed line (between the local receiver 109 and the command processor 111). The local receiver 109 detects (i.e., scans) the triggering information (i.e., the triggering labels, which are included in the PDT, coupled to said command information) from the received transport stream. In case the triggering information is found in a transport stream, the local receiver 109 transmits the triggering information coupled to said command information to a command processor 111. In this case the detection of triggering data coupled to command information is done in the local receiver 109 instead of the demultiplexer 110. Therefore, the demultiplexer 110 does not detect the triggering data coupled to command information from the data stream received from the local receiver 109. The other steps in the process for localizing a data stream follows the steps described above.

The concept of the present invention also covers the situation when the triggering data coupled to command information is received from the demultiplexer 110 or from the local receiver 109 to the command processor 111, the command processor 111 do not receive any command information for altering the data stream received from the remote transmitting means 101. In this case, the command processor 111 sends a command to a controller 112 to provide the data stream to the remultiplexer 117. At the same time the command processor 111 transmits e.g., SI (Service Information) data to the remultiplexer 117 in order to enable the remultiplexer 117 to provide the triggering information coupled to command information or some additional information to the data stream. In this case the unnecessary decoding and encoding can be eliminated. This kind of case may occur, when the triggering data coupled to command information is received in the data localization means 103, but the triggering data coupled to command information is not directed to this data localization means 103 but to some other data localization means. It may also occur when the command information is directed to the user of the service and not to the data localization means 103.

The present invention also covers the situation when the controller is not used in the data localization means 103. In this case, the demultiplexer 110 transmits the received data stream to the decoder 115, which in turn provides the data stream to the mixer 114. When localizing the data stream, the command processor 111 transmits the commands to the server 113 and to the mixer 114 to perform the data stream localization. If the command received in the mixer 114 comprises that the data stream is to be replaced with another data stream received from the server 113, the mixer 114 closes the first port through which the data stream received from the remote transmitting means 101 is received. At the same time the mixer 114 opens the second port through which the localized data stream is received from the server 113. The port handling may be defined to last a certain time, after which the mixer 114 reopens the first port allowing the data stream received from the remote transmitting means 101 to enter the mixer 114, and closes the second port to eliminate the data stream received from the server 113 to enter the mixer 114. The mixer 114 provides the data streams to the encoder 115 as described in the preferred embodiment of the present invention.

Even though the above description of the system according to the present invention discloses a system for localizing a video data, the system may be utilized e.g., for localization in a Digital Audio Broadcasting (DAB) environment or for the localization in multicast applications transmitted over the Internet.

In the multicast applications, the data that is to be provided to the users of the service is arranged into packets, which may provide a data stream as known to the skilled person in the art. When the data packets are multiplexed in the multiplexer 107 of the remote transmitting means 101 together with triggering data coupled to command information, the multiplexed data stream is provided to the data localization means 103 through the network 102. When the multiplexed data stream is received in the local receiver 109 of the data localization means 103, the local receiver 109 detects triggering data coupled to command information from the multiplexed data stream. Alternatively, the local receiver 109 provides the received multiplexed data stream to the demultiplexer 110, which detects for triggering data coupled to command information from the multiplexed data stream. In case the local receiver 109 or the demultiplexer 110 finds the triggering data coupled to command information, it transmits the triggering data coupled to command information to the command processor 111 and demultiplexes the data stream in the demultiplexer 110. The further process for localizing the data stream in a multicasting environment follows the same principles as described with reference to DVB environment.

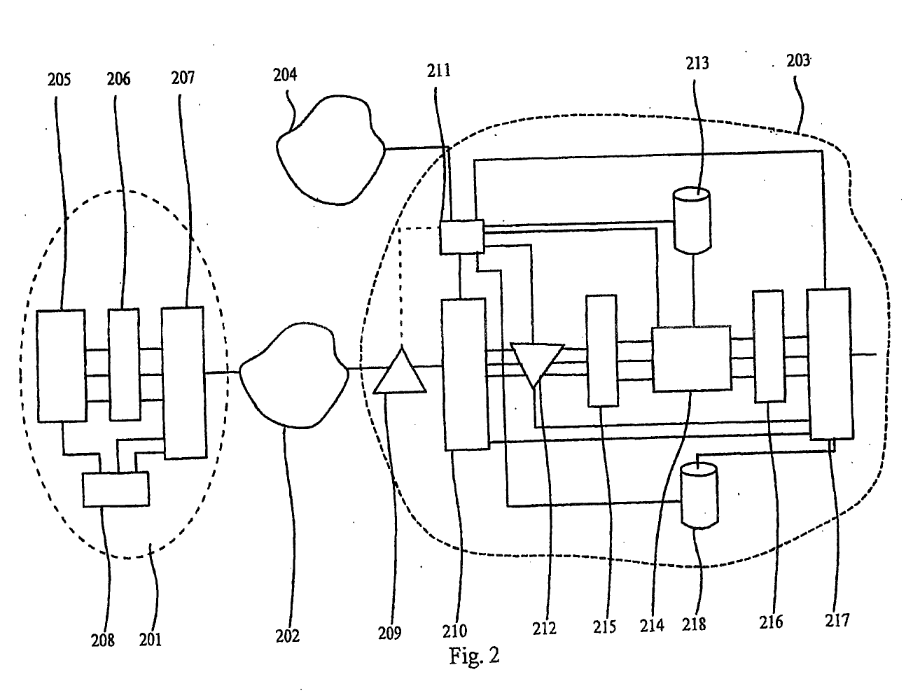

FIG. 2 shows an alternative embodiment of the present invention. FIG. 2 shows remote transmitting means 201, a transportation network 202, and data localization means 203, which corresponds to the similar features described with reference to FIG. 1. FIG. 2 additionally shows an additional network 204 (e.g., an Internet Protocol (IP) network) connected to data localization means 203. This additional network (functions as separate transmitting means) 204 of the inventive concept provides a possibility for controlling the data localization means 203 via e.g., an IP network 204. This may be the case e.g., when the local authorities must transmit information of the environmental disaster in a certain local area.

In the alternative embodiment of the present invention, the remote transmitting means 201 and the transportation network 202 functions as described with reference to FIG. 1. When there is a need for e.g., local authorities to inform the television viewers locally, the following process will take place. The local receiver 209 in a data localization means 203 receives the transport streams transmitted from remote transmitting means 201, providing the information for further processing as described with reference to FIG. 1. Local authorities transmit the triggering information coupled to command information via e.g., IP network 204 to a command processor 211 of data localization means 203. When the command processor 211 receives the triggering data coupled to said command information, the command processor 211 informs a controller 212 (or a mixer 214) to block the data stream received from a demultiplexer 210. Essentially similarly the command processor 211 informs a server 218 to provide e.g., a certain video stream (a news reader warning of the television viewers in a certain area of the approaching hurricane) or some other data. The server 218 provides the data stream (i.e., a video stream or a like) to an encoder 216 and/or to a remultiplexer 217 for transmitting the stream to the viewers of a local broadcasting area.

After broadcasting the information defined e.g., by local authorities, the controller 212 (or the mixer 214) stops blocking the data stream provided by the demultiplexer 210, and data localization means continues to function as described with reference to FIG. 1. The timing of the information that is broadcasted may be defined by e.g., local authorities, or the server 218 may send a notification of the ending of the local information to the command processor 211.

Alternatively, the remultiplexer 217 may be used for blocking the data stream provided from remote transmitting means 201 and to modify the data stream that is transmitted to the viewers. In this case the command processor 211 sends the command for the remultiplexer 217 to block the data stream received in data localization means 203 and to modify the data stream that is transmitted to the viewers.

Also it may be the case, when the local authorities want to inform the viewers by adding a textual information (or an application such as providing an Internet link from which the viewer may obtain additional information) to the data stream, the remultiplexer 217 receives the data stream from the encoder 216 and the textual data stream from a server 218, and multiplexes the data streams into a transport stream that is further transmitted to the viewers.

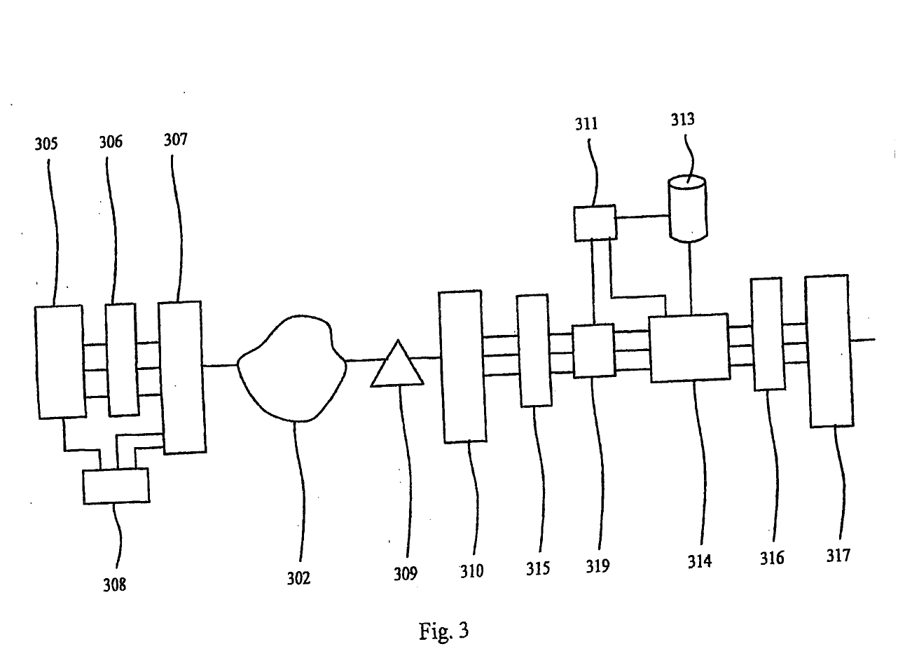

FIG. 3 shows schematically an alternative embodiment of the present invention. In FIG. 3, a transmit unit 305 provides a digital data stream to an encoder 306. The digital data stream is encoded in an encoder 306, which in turn provides the encoded data stream to a multiplexer 307. The multiplexer 307 multiplexes the data streams into a transport stream together with additional information (such as Service Information (SI)) provided by an automation system 308, containing triggering information coupled to command information. The automation system 308 further controls the transmit unit 305 by providing e.g., playlist that informs the transmit unit 305 of timing, etc. The transport stream is transmitted from the multiplexer 307 to a local receiver 309 via a transportation network 302, such as cable network.

After receiving the transport stream in a local receiver 309, the local receiver 309 transmits the transport stream to a demultiplexer 310. The demultiplexer 310 demultiplexes the transport stream into several data streams, which are provided to a decoder 315 together with the Service Information provided into the transport stream in the multiplexer 305. The decoder 315 decodes the data streams. There may be different decoder for each type of the data streams, i.e., a video decoder for a video stream or an audio decoder for an audio stream.

The decoder 315 transmits the data stream to a triggering means 319, which detects (i.e., scans) the data streams for a triggering data (e.g., triggering label) coupled to said command information. If the triggering data is found in the triggering means 319, the triggering means 319 provides the triggering data coupled to said command information to a command processor 311 for further execution. The command processor 311 receives the information included in one or several commands and provides them to the device identified in the command to execute an operation that is defined and identified in the command. In the exemplary presentation shown in FIG. 3, the command processor 311 provides commands to two different devices, i.e., to a server 313 and to a mixer 314.

In case the command comprised that an audio stream of the movie, which will be provided to the television viewers in certain city, should be changed, the command processor 311 transmits a command for a server 313 to provide an audio stream to the mixer 314, and similarly transmits a command for a mixer 312 to modify the data stream provided by the decoder 315. The data stream provided by the decoder 315 may be modified in such a way that the mixer 314 blocks an audio stream of the movie and replaces it with an audio stream provided by the server 313.

After modifying the data stream, the mixer 314 transmits the modified data stream(s) to an encoder 316 for further transmission. The encoder 316 encodes the modified data stream(s) and transmits it (them) to a remultiplexer 317, which multiplexes the data stream(s) into a transport stream that is transmitted to the viewers in that certain area. The area may be e.g., a city or nationwide area.

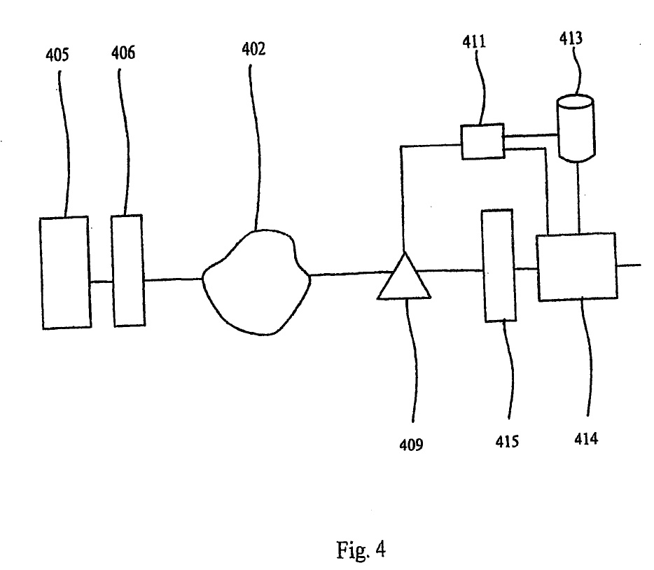

FIG. 4 shows schematically an alternative embodiment of the present invention. In FIG. 4, a data stream is provided from a transmit unit 405 to an encoder 406. The data stream includes triggering data coupled to command information, which are in a data stream provided to the encoder 406.

The data stream is transmitted from an encoder 406 through a network 402 to a local receiver 409. The local receiver 409 receives the data stream detects the triggering data coupled to said command information. If such triggering data is found in a local receiver 409, the local receiver 409 transmits the triggering data together with the coupled command information to a command processor 411. The local receiver 409 further transmits the data stream to a decoder 415, which decodes the data stream and transmits it to a mixer 414 for further processing.

The command processor provides the command information to devices identified in the command information. In the exemplary presentation of the present invention as shown in FIG. 4, the command processor 411 transmits the commands to two different devices. The command processor 411 transmits a command to a server 413, which executes the function(s) defined in the command information, e.g., transmitting an audio file to the mixer 414. Essentially similarly the command processor 411 transmits a command to the mixer 414 to modify the data stream. The mixer 414 modifies the data stream e.g., by replacing a part (or the whole) of an audio section of the data stream with the data file received from the server 413.

After modifying the data stream, the mixer 414 retransmits the modified data stream. The data stream is then provided to the users of the service.

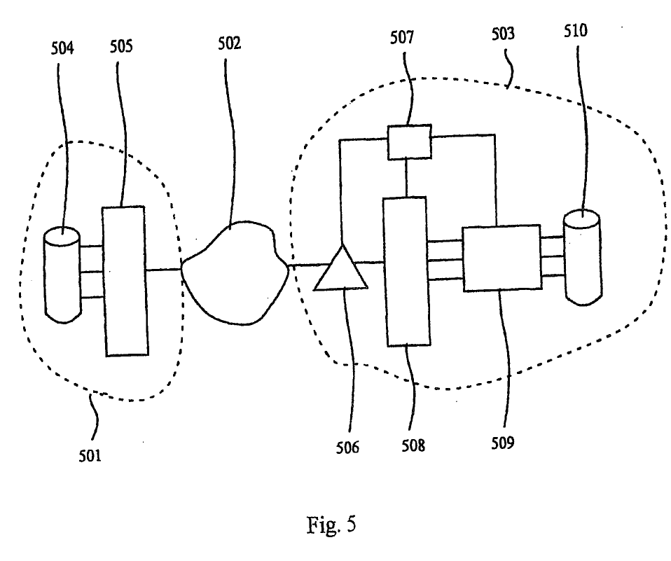

FIG. 5 shows an alternative embodiment of the present invention. The system shown in FIG. 5 illustrates the possibility for an international service provider to provide localized services to the users in a communications network, such as an Internet.

The international service provider has a server 504 (or a like) wherefrom the service users can download the service.

The service may be downloaded from e.g., URL address www.YYY.com. FIG. 5 also shows a multiplexer 505 for multiplexing the data packets (i.e., data stream) provided from the server 504 of the international service provider. The server 504 of the international service provider and the multiplexer 505 form a remote transmitting means 501.

FIG. 5 also shows a network 502 for enabling the transmission of the data stream from the remote transmitting means 501 to a data localizing means 503. The network can be e.g., an IP network, which is known for the person skilled in the art, and therefore, not described in detail.

The data localizing means 503 comprises a local receiver 506, a command processor 507, a demultiplexer 508, an operational processing means 509 and a server 510 (or a like device for storing data, etc.).

As for illustrating this concept of the present invention more closely, we will consider the case in which the international service provider is a news service provider that has a headquarter in London. Further the news service provided includes e.g., international news, local news, sports section, economy section, advertisement.

The international news service provider updates the news at least once a day, when the news will obtain a new layout. The news is provided to the server 504. Every time the news provider updates the content of the server, the following process will occur.

An automation means in a server provides triggering data coupled to command information, wherein the triggering data enables the receiving party to notice the need for a change in a data stream (or in data packets). The command information includes e.g., what operations should be done to the data stream provided from the remote transmitting means 501, etc. The data stream and triggering data coupled to command information are multiplexed in the multiplexer 505 to form a transport stream. The data stream and the triggering data coupled to command information are transmitted from the remote transmitting means 501 to the data localization means 503 through the network 502.

The local receiver 506 receives the data stream and triggering data coupled to command information, and detects the stream for a triggering data coupled to command information. In case the triggering data coupled to command information is found, the local receiver 506 transmits the triggering data coupled to command information to a command processor 507. Simultaneously the local receiver 506 transmits the data stream to a demultiplexer 508.

Alternatively, the local receiver 506 transmits the data stream and triggering data coupled to command information to the demultiplexer 508, which detects the stream for a triggering data coupled to command information. In case the triggering data coupled to command information is found, the demultiplexer 508 transmits them to the command processor 507 and demultiplexes the data stream(s).

The command processor 507 provides the command information to an operational processing means 509 (such as translation device, etc.), which in turn receives the data stream from the demultiplexer 508. The operational processing means 509 alters the data stream received from the demultiplexer 509 according to commands received from the command processor 507 and retransmits the altered data to a server 510 (or a like), wherefrom the users may obtain the news service.

The modification of the data stream may be e.g., a translation of the news into a local language, or adding local news into the news format by replacing the local news section provided by the international news provider, or replacing the advertisements to local advertisements.

When translating the news, the command processor 507 informs a translation device to translate the text or a speech (or a like) into the local language. For example, if the international news provider is in London and the data localization means 503 is in Helsinki, the translation device translates the text or speech from English into Finnish. In this case the user of the news service in Helsinki may enter the news server in Finland (e.g., from URL-address www.YYY.fi) that provides the news in his own language.

In case the local news is added to the news service, the command processor 507 informs the operational processing means 509 to obtain the local news from a predefined source and to implement the local news to the news service.

If the local advertisement is implemented to the news service, the command processor 507 may inform the operational processing means 509 to remove the advertisement from the data stream provided by the remote transmitting means 501 and to replace the local advertisement to the news service. This enables the international service providers to advertise locally, which is more efficient than advertising certain advertisements on international base.

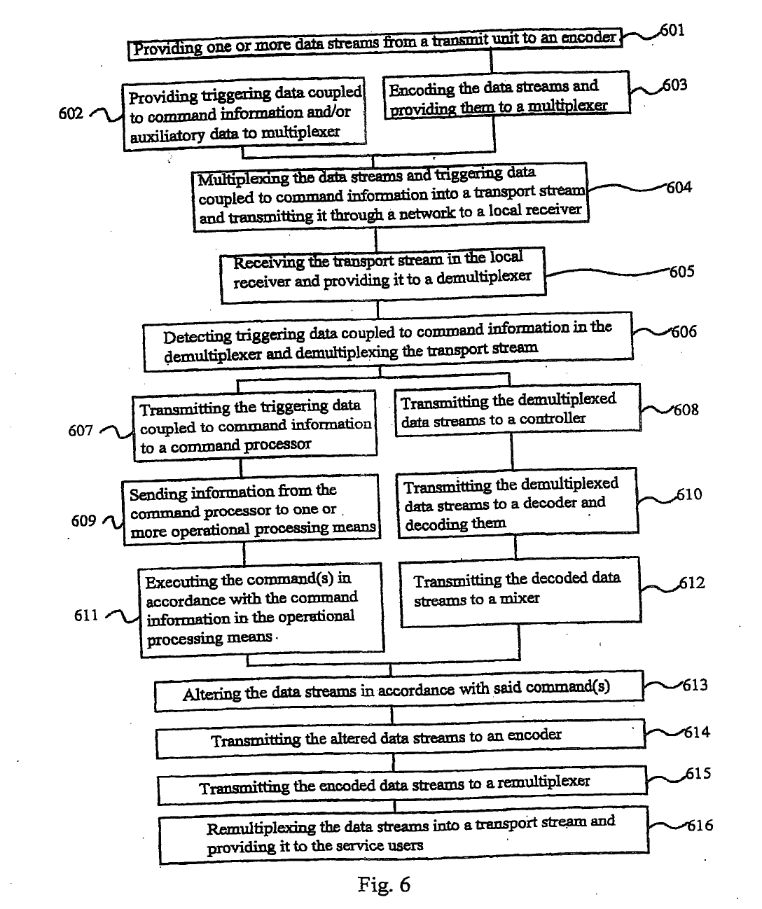

FIG. 6 is a flowchart illustrating the method of the preferred embodiment of the present invention. In step 601 of FIG. 6, a transmit unit provides one or more data streams to an encoder, which encodes the data streams (in step 603) and provides the encoded data streams to a multiplexer. Triggering data coupled to a command information and/or auxiliary data is provided to the multiplexer (step 602). The multiplexer multiplexes the data streams and triggering data coupled to command information into a transport stream (step 604). The multiplexer further transmits the transport stream through a network to a local receiver.

The local receiver receives the transport stream transmitted from the multiplexer, and provides the transport stream to a demultiplexer (step 605). The demultiplexer detects if triggering data coupled to command information is found from the transport stream (step 606). The multiplexer further demultiplexes the transport stream into data streams. In case the triggering data coupled to command information is found from the transport stream, the demultiplexer transmits them to a command processor (step 607). The multiplexer also transmits the demultiplexed data streams to a controller (step 608).

In step 609, the command processor sends the information to one or more operational processing means, while the demultiplexed data streams are transmitted from a controller to a decoder, which decodes the demultiplexed data streams (step 610). The decoder transmits the decoded data streams to a mixer (step 612). In step 611, the operational processing means executes the commands in accordance with the command information. The mixer further alters the data streams in accordance with said command(s) (step 613) and transmits the data streams to an encoder (step 614), which in turn transmits the data streams to a remultiplexer (step 615). Remultiplexing the data streams into a transport stream for providing them to the users of the service is done on step 616.

It will be appreciated by the skilled person in the art that various modifications may be made to the above-described embodiments without departing from the scope of the present invention, as disclosed in the appended claims. The embodiments of the invention may utilize various tasks, such as a local advertisement, local news, local dubbing, local subtitling, local text content, local censoring replacement, local identification, or local application.

1. A method for localizing data in a digital network environment, said method comprising the steps of:
providing a digital data stream at a remote transmitting means,
providing triggering data coupled to command information capable of altering said digital data stream,
receiving said digital data stream and said triggering means coupled to said command information at a local receiving means,
in said local receiving means, detecting said triggering data in a detecting means,
in response to any detected triggering data, sending said command information to command processing means,
sending information from said command processing means to one or more operational processing means for execution of command(s) in accordance with said command information,
altering said received digital data stream in accordance with said command(s).

2. A method according to claim 1, wherein said triggering data coupled to said command information and said digital data stream are transmitted together from said remote transmitting means.

3. A method according to claim 1, wherein said triggering data coupled to said command information is transmitted from a separate transmitting means.

4. A method according to claim 1, wherein said digital data stream which is to be localized comprises broadcasting data such as a service stream in a Digital Video Broadcasting (DVB) or a Digital Audio Broadcasting (DAB) network or multicasting data such as a service stream in communications network.

5. A method according to claim 1, wherein said digital data stream which is to be localized comprises information retrievable from an information network such as the Internet.

6. A method according to claim 1 or 4, wherein said triggering data coupled to said command information is introduced into a private table which is combined with said digital data stream.

7. A method according to claim 6, wherein said triggering data coupled to said command information is introduced into said table by an automation means.

8. A method according to claim 1, 4 or 5, wherein said triggering data coupled to said command information comprises auxiliary data which is combined with or introduced into said digital data stream.

9. A method according to claim 1, wherein said digital data stream comprises a stream for a single service or part thereof in a multiple service stream composed of several independent services in a DVB or DAB network said multiple service stream being transmitted by a remote transmit unit.

10. A method according to claim 1 wherein said digital data stream comprises a single service or communication data stream among multiple data in a multicast or communications network.

11. A method according to claim 9 or 10, wherein said multiple service or data stream comprises encoded data which is combined in a multiplexer means with said triggering data coupled to said command information.

12. A method according to claim 11, wherein the encoded and multiplexed service or data stream is transmitted as a transport stream from a remote transmitting means through a network to said local receiving means where it is demultiplexed to provide several independent service or data streams.

13. A method according to claim 12, wherein at least said single service or data stream is decoded after demultiplexing.

14. A method according to any one of the preceding claims, wherein said triggering data comprises a triggering label comprising a set of characters recognizable by a triggering device as a command for initiating an operation defined by said command information.

15. A method according to any one of the preceding claims, wherein said command information is capable of causing modification of said digital data stream and includes one or more commands to be executed for causing such modification.

16. A method according to claim 15, wherein said commands are selected from direct commands and composite commands.

17. A method according to claim 16, wherein said direct command includes digital information such as operational processor identification, operation identification, operation parameters, delay time, and/or the like parameters.

18. A method according to claim 16, wherein said composite command includes digital information such as operational processor identification, operation identification, operation parameters, delay time and/or the like parameters.

19. A method according to claim 12 or 13, wherein said triggering data is included in a private table in a multiplexed data stream and reading of said triggering data causes command(s) included in said command information to be sent to said command processing means for execution.

20. A method according to claim 19, wherein said command processing means sends direct and/or composite command(s) to one or more operational processing means identified in said command information.

21. A method according to claim 20, wherein said operational processing means comprise a demultiplexing device, a decoding device, an encoding device, a remultiplexing device, a server device, a mixer device, a text generator device, a data carousel, or the like service influencing device.

22. A method according to claim 21, wherein said single service stream comprises a program stream in a DVB or DAB network and said single stream is routed through a first port in a video or audio stream mixing device and, in response to a command received from said command processing means, said first port is closed and a second port is opened allowing another video or audio program stream to modify and/or replace said single service stream.

23. A method according to claim 22, wherein a command is simultaneously received in a video or audio server device to send a selected video or audio program stream to said second port for replacing said single service stream.

24. A method according to claim 21 or 22, wherein said first port in said mixing device is reopened and said second port closed after a delay time determined by said command information to allow said single service stream to be reassumed.

25. A method according to claim 24, wherein said service stream is routed after said mixing device to encoding and remultiplexing for further transmission to local users.

26. A method according to claim 21, wherein said single service stream comprises an application or data stream in a network and said single stream is deleted in a remultiplexing device totally or for a delay time in response to a command received from said command processing means.

27. A method according to claim 26, wherein a command is simultaneously received in a data carousel to send a selected data stream or package to said remultiplexing device for replacing said single service stream.

28. A method according to claim 21, wherein said single service stream comprises a service or a data stream in a network and wherein said single stream is modified by the combining of an additional data stream with said single stream in a remultiplexing device in response to a command received from said command processing means.

29. A method according to claim 21, wherein said single stream comprises a service or communication data stream in a communications network and, in response to a command received from said command processing means, said single stream is modified by a selected data stream introduced from a server device.

30. A method according to claim 23, 26, 27 or 29, wherein said selected stream comprises a local stream such as a local advertisement, local news, local dubbing, local subtitling, local text content, local censoring replacement, local identification, or local application.

31. A digital transmission system for localizing data in a digital network environment, said digital transmission system comprising:
remote transmitting means for transmitting digital data streams,
means for providing triggering data coupled to command information,
local receiving means for receiving the digital data stream and triggering data coupled to command information,
means at said local receiving means for detecting said triggering data,
triggering means arranged, in response to any detected triggering data, to send said command information to command processing means,
information transmitting means for sending information from said command processing means to one or more operational processing means for execution of command(s) in accordance with said command information,
means for altering said received digital data stream in accordance with said command(s).

32. A digital transmission system according to claim 31, wherein said means for providing triggering data coupled to command information is said remote transmitting means.

33. A digital transmission system according to claim 31, wherein said means for providing triggering data coupled to command information is a separate transmitting means.

34. A digital transmission system according to claim 31, wherein said network comprises a Digital Video Broadcasting (DVB), a Digital Audio Broadcasting (DAB) network, a multicasting network or a communications network.

35. A digital transmission system according to claim 31, which further comprises means for adding said triggering data coupled to said command information into or into combination with said digital data stream.

36. A digital transmission system according to claim 31, which further comprises automation means for introducing said triggering data coupled to said command information data into a private table of a digital broadcasting or multicasting signal.

37. A digital transmission system according claim 31, wherein said remote transmitting means includes encoding means to encode digital data streams and multiplexing means for multiplexing digital data streams with one or more other data streams to be transmitted.

38. A digital transmission system according to claim 31, which further comprises means for demultiplexing and decoding data streams received in said receiving means.

39. A digital transmission system according to claim 31, wherein said operational processing means comprise a demultiplexing device, a decoding device, a remultiplexing device, an encoding device, a mixer device, a server device, a text generator, a data carousel, or the like processing device.

40. A data transmitting means for localizing data in a digital network, said data transmitting means comprising:
a transmit unit for transmitting digital data streams,
means for combining a digital data stream to be transmitted with triggering data coupled to command information, said command information being capable of causing a modification of said digital data stream at local receiving means.

41. A data transmitting means according to claim 40, wherein said network comprises a broadcasting network such as a Digital Video Broadcasting (DVB) or a Digital Audio Broadcasting (DAB) network, a multicasting network or a communication network such as the Internet.

42. A data transmitting means according to claim 40, which further comprises means for adding said triggering data coupled to said command information into or into combination with said digital data stream.

43. A data transmitting means according to claim 40, which further comprises automation means for introducing said triggering data coupled to said command information data into a private table of a digital broadcasting or multicasting signal.

44. A data transmitting means according to claim 40, wherein said transmit unit includes encoding means for encoding said digital data stream and multiplexing means for multiplexing said digital data stream with one or more other data streams to be transmitted and with said triggering means coupled to said command information.

45. A data localizing means for localizing data in a digital network environment comprising:
local receiving means for receiving a digital data stream and triggering data coupled to command information from remote transmitting means,
means at said local receiving means for detecting said triggering data,
triggering means arranged, in response to any detected triggering data, to send said command information to command processing means,
information transmission means for sending information from said command processing means to one or more operational processing means for execution of command(s) in accordance with said command information,
means for altering the received digital data stream in accordance with said command(s).

46. A data localizing means according to claim 45, which comprises separate local receiving means and/or separate remote transmitting means for said digital data stream and said triggering data, respectively.

47. A data localizing means according to claim 45, which further comprises means for demultiplexing and/or decoding received encoded data streams.

48. A data localizing means according to claim 45, wherein said operational processing means comprise a demultiplexing device, a decoding device, an encoding device, a remultiplexing device, a mixer device, a server device, a text generator, a data carousel, or the like.

49. A data localizing means according to claim 48, wherein said mixer device is a video or audio stream mixer and comprises a first and a second port, which ports can be opened and closed to allow a video or audio program stream to modify and/or replace another program stream.

50. A data localizing means according to claim 48, wherein said remultiplexing device comprises a remultiplexer for deleting said digital data stream, modifying said digital data stream and/or adding data into or into combination with said digital data stream.

51. Use of a system for localizing data in a digital network environment, said use comprising:
controlling local data in a remotely transmitted digital data stream in a data localization means based on triggering data coupled to command information provided from a transmitting means, said command information being capable of causing modification of said digital data stream at local receiving means.

52. Use according to claim 51, wherein said digital data stream which is to be localized comprises multicasting data or broadcasting data such as a program stream in a Digital Video Broadcasting (DVB) or a Digital Audio Broadcasting (DAB) network, or information retrievable from an information network such as the Internet.

53. Use according to claim 51, wherein said local data comprises insert or replacement data introduced into the digital data stream in response to commands included in said command information.

54. Use according to claim 51, wherein said local data comprises local advertisement(s), local news, local dubbing, local subtitling, local text content, local censoring replacement, local identification, or local applications.

55. Use according to claim 51, which comprises providing local news and/or local inserts in an international DVB or DAB transmission.

56. Use according to claim 51, which comprises providing local news and/or local inserts in an international news service on the Internet.

57. Use according to claim 51, which comprises causing selected interrupting local information to be introduced into broadcasting and/or communications networks.

58. Use according to claim 51, which comprises preventing selected services from being transmitted to local receivers in a broadcasting and/or communications network.
